(19) United States
(12) Patent Application Publication
(10) Pub. No.: US 2010/0107341 A1
(43) Pub. Date: May 6, 2010

(54) Single Container Type for Multiple Fabric Care Products

(76) Inventors: Brian Lee Floyd, Cincinnati, OH (US); Ian Andrew Carnduff, New York, NY (US); Ian Josiah Swanson, New York, NY (US); Paul Frank Diehl, Brooklyn, NY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/351,274

(22) Filed: Jan. 9, 2009

(30) Foreign Application Priority Data
Nov. 6, 2008 (CA) 2,642,061

(51) Int. Cl. C11D 3/00

(52) U.S. Cl. 8/137; 510/527

(57) ABSTRACT

The present invention relates to asymmetric containers for fabric care products where a single container type may be used for two or more different fabric care products.

### CROSS-REFERENCE TO RELATED APPLICATIONS

This application claims priority to Canadian Application Serial No. 2,642,061, filed Nov. 6, 2008, which is herein incorporated by reference.

### FIELD OF THE INVENTION

The present invention relates to asymmetric containers for fabric care products where a single container type may be used for two or more different fabric care products.

### BACKGROUND OF THE INVENTION

In the interests of reducing costs and decreasing the time to take a new product to market, there is a need for a single container type to serve for more than one fabric care product. Although varying labels and bottle color is one way to make an ornamental distinction between products, these approaches alone often fail to provide enough distinction for an on-shelf marketing impact to the shopper. A single container type for different products saves costs in testing, producing molds and other such expenses associated with two different container types. Therefore, there is a need for a single container for different fabric care products to save costs and time, yet provide the ornamental distinction and marketing impact that two different bottle types provide.

See U.S. Pat. No. 5,350,078.

### SUMMARY OF THE INVENTION

The present invention attempts to address this, and other needs, by providing in a first aspect of the invention, a fabric care product comprising a container containing fabric care composition. The container comprises a base, a first panel and a second panel where the panels extend vertically above the base to form a cylindrical opening at about the top of the container. The base comprises a length and a width, wherein the length is at least longer than the width. The first panel and second panel are adjacent along a longitudinal plane. The longitudinal plane is a flat linear plane that generally symmetrically divides an axial plane of the cylindrical opening and divides an axial plane the length of the base. The first panel is neither generally symmetrical nor generally a mirror image of the second panel. Two different ornamental impressions of the bottle can be provided to shoppers depending on how the bottle is oriented to the shopper, i.e., which panel is facing the shopper (and vice versa). Two different fabric care products—each with its own unique front panel—can be marketed to the shopper using the same container type.

Another aspect of the invention provides for a method of treating fabric comprising the step of dosing composition from the product of the present invention to a laundry washing machine or laundry washing basin.

Yet another aspect of the invention provides for an array of fabric care products comprising a first product and a second product. The first product comprises a first container containing a first fabric care composition, wherein the first container is a type previously described. The first product also comprises a first front label and a first back label affixed to the first container. The second product comprises a second container containing a second fabric softener composition, wherein the second container is the same type as the first container. The second product also comprises a second front label and a second back label affixed to the second container. The first panel of the first product comprises the first front label; and the first panel of the second product comprises the second back label.

Lastly kits comprising one or more of the products of the present invention are also provided. Instructions for using the products may also be included. Compositions from the products may be dosed to laundry washing machines for the purposes of treating laundry.

### BRIEF DESCRIPTION OF THE DRAWINGS

FIG. 1 of the drawings is a perspective view of one embodiment of a container of the present invention.

FIG. 2 is a front view of the container of FIG. 1.

FIG. 3 is a back view of the container.

FIG. 4 is a right side view of the container.

FIG. 5 is a left side view of the container.

FIG. 6 is a top view of the container

FIG. 7 is a bottom view of the container.

FIG. 8 is perspective of a cap that is suitable to be used with the container of FIG. 1.

FIG. 9 is a front view of the cap of FIG. 8.

FIG. 10 is a right side view of the cap.

FIG. 11 is a left side view of the cap.

FIG. 12 is back view of the cap.

FIG. 13 is a top view of the cap.

FIG. 14 is a bottom view of the cap.

### DETAILED DESCRIPTION OF THE INVENTION

The present invention provides for a container type that, depending in part upon its orientation, may be used by different fabric care products. Designing and qualifying multiple containers for different products for the fabric care category is expensive and time consuming. Nevertheless, container ornamentation is important to shoppers when selecting products to purchase. The present invention attempts to balances these costs and yet provides a container having different ornamentation, depending how the container is oriented, to differentiate products/brands and to capture the attention of the shopper.

The products of the present invention comprise a container containing a fabric care composition. Non-limiting examples of fabric care compositions include a fabric softener composition (e.g., U.S. Pat. No. 7,135,451) and a laundry detergent (e.g., U.S. Pat. No. 7,439,217 and U.S. Pat. No. 7,435,715).

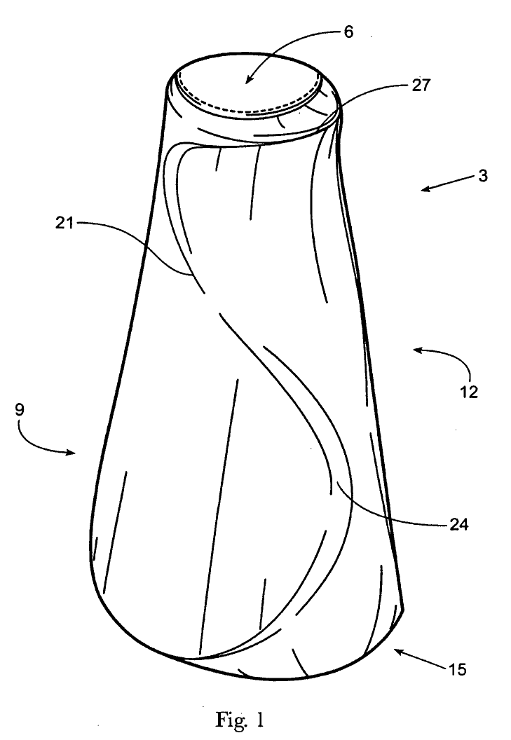

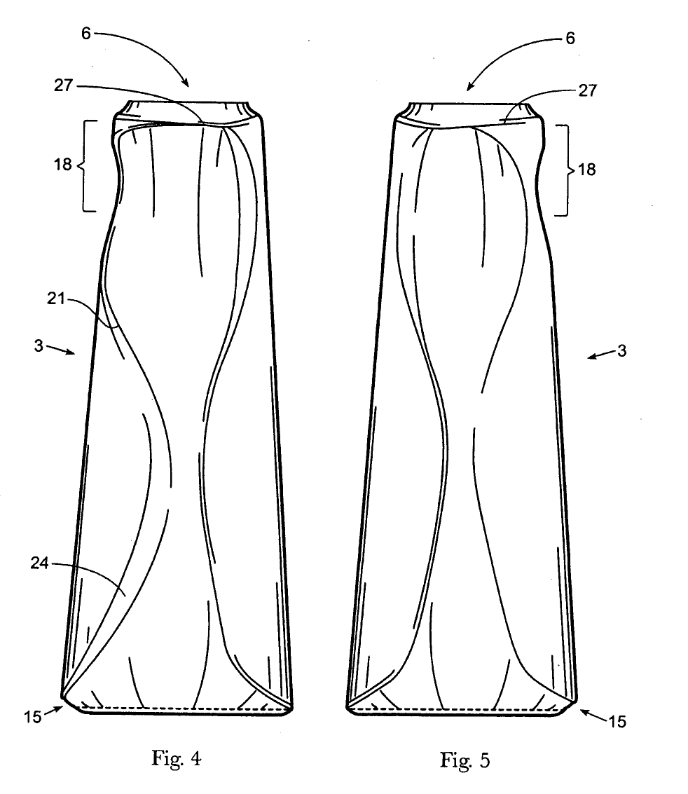

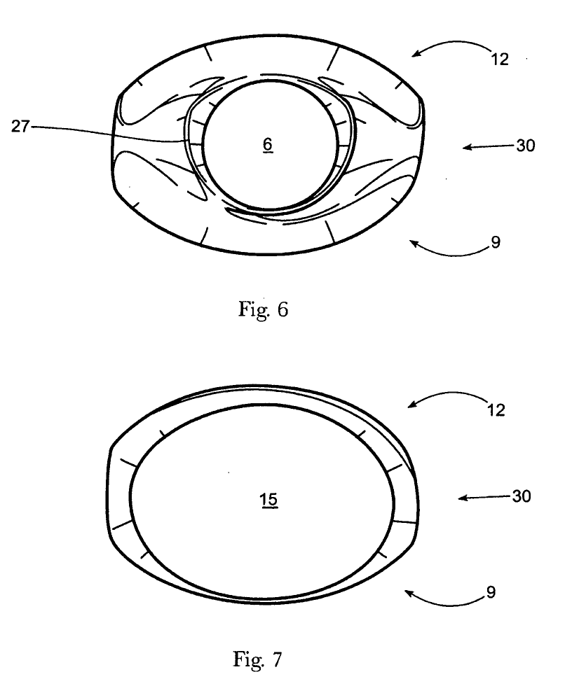

Referring to FIGS. 1-7, container 3 comprises a base 15, a first panel 9 and a second panel 12 extending vertically above the base 15 to form a cylindrical opening 6 at about the top of the container 3. In one embodiment, the container may contain from about 600 ml to about 3000 ml, alternatively from about 750 ml to 2250 ml, alternatively from about 1,000 ml to about 2,000 ml of fabric care composition. The container may be comprised of plastic such as a high density polyethylene (HDPE) or a polyethylene terephthalate (PET), which preferably can be recycled. The container may be blow molded from these plastics.

The base 15 is at about the bottom of the container 3. The base 15 comprises a length dimension and a width dimension, wherein preferably the length dimension is equal to or longer than the width dimension. In one embodiment, the length of the base is from about 10 cm to about 17 cm, alternatively from about 12 cm to about 15 cm. In another embodiment, the width of the base is from about 5 cm to about 12 cm, alternatively from about 7 cm about 10 cm. In yet another embodiment, the length of the base is from about 1.1 to about 3 times, alternatively from about 1.3 to about 2 times, greater than its width. The base occupies a foot print area on shelf, in one embodiment, comprising from about 50 cm2 to about 210 cm2, alternatively from about 80 cm2 to about 180 cm2, alternatively from about 100 cm2 to about 160 cm2. Generally, and without wishing to be bound by theory, a container in fabric care that has a length longer than its width provides a container with more surface area to advertise to the shopper (so called “billboarding”) its brand name and other benefits to entice the shopper to select the product when its on a store shelf.

The cylindrical opening 6 is substantially at the top of the container 3. The opening 6 allows for the filling of the container 3 and the dispensing of fabric care compositions from the container 3. In one embodiment, the opening of the container is removably sealable. Non-limiting examples of mechanisms to provide such seals include sealing press taps, self-draining spouts, traditional spouts, double walled caps, screw caps, pull caps, snap caps, flip caps, vented caps, and combinations thereof. The container may have a transition functionally attached to the opening such as U.S. Pat. No. 4,550,862. In one embodiment, the overall height of the product (including any caps, etc.) is from about 20 cm to about 40 cm, alternatively from about 25 cm to about 35 cm. A non-limiting example of a double-walled cap is U.S. Design 548,076. A non-limiting example of a flow-back spout is US 2007-0257057.

The container 3 comprises a first panel 9 and a second panel 12. The first panel 9 and second panel 12 are adjacent along a longitudinal plane. The longitudinal plane is a flat linear plane that generally symmetrically divides an axial plane of the cylindrical opening 6, and divides an axial plane along length of the base 15. Although the terms “panels” are used, one skilled in the art will readily appreciate that in those embodiments where the container is blow-molded, there are no individual distinct walls that are combined but rather the container is made from a single parison. The use of the term “panels” is referring to the two respective halves or sides of the container. Often the seam that is visible on a blow molded container is an artifact of the where the respective two halves or sides of the mold attach during the blow modeling processes. The seam on the bottle is often on the same plane as the aforementioned longitudinal plane. These seams are often on either side of the labels that are affixed to the container as not to be readily visible to the shopper when the product is displayed on store shelf. In yet another embodiment, the longitudinal plane divides the axial plane of the length of the base generally symmetrically.

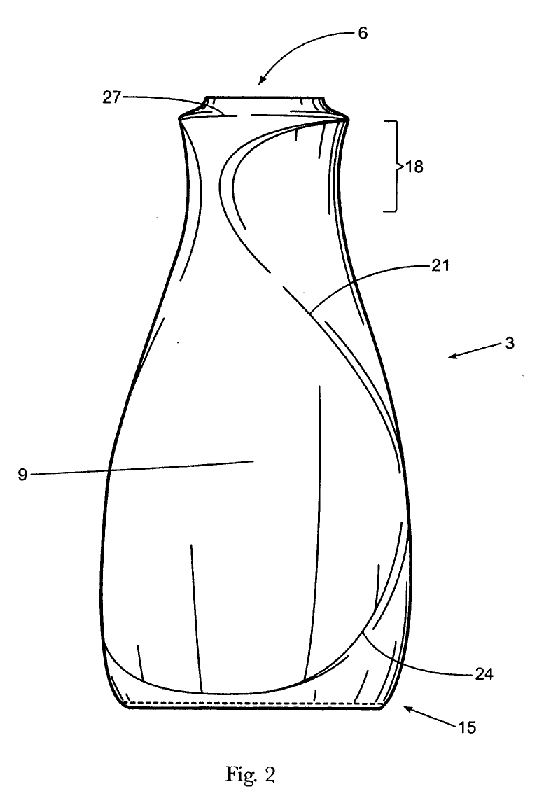

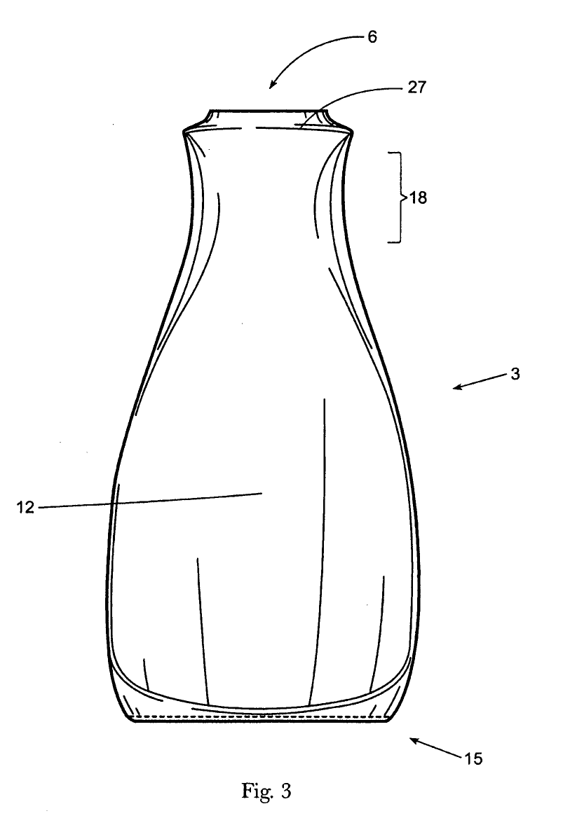

The first panel of the container is neither generally symmetrical nor generally a mirror image of the second panel (and vice versa). This non-symmetry and non-mirror image can be achieved by having design elements integral to one panel and not integral to the other panel (or vice versa). For example, in the front view of the container 3 in FIG. 2, the first panel 9 comprises a first design element 21 and a second design element 24. These design elements 21, 24 are absent in the second panel 12 of the back view of the container 3 in FIG. 3. There is a different ornamental impression presented to the shopper looking at front view of the first panel 9 of FIG. 2 verses the back view of panel 12 of FIG. 3.

These design elements may be a protuberance or a curvilinear ridge or other such modification made to the container's material (e.g., via the mold for blow molding). Having the respective panels each with different design elements provides a single container type to be presented to the shopper to have different ornamentation depending upon which panel (i.e., either the first panel or the second panel) is facing the shopper, i.e., which panel is used as the “front” of the package.

The use of “generally” in the terms “generally symmetrical” and “generally a mirror image” is used to acknowledge that certain molding imperfections, indicia (such as the recycling symbol), or functional attributes (threading in the container opening), and the like, may be present in the invention but do not materially affect the ornamentation of the container.

The orientation of the container can be varied to shopper by where a front label and a back label are affixed to the container. For example, a front label may be affixed to the first panel of the container and a back label affixed to the second panel for a first product. For a second product, the labeling can be reversed on the same container type to achieve a different container ornamentation that is presented to the shopper. It is typically the front label that dictates the “front” of a product as the product is presented to the shopper on store shelf. That is, the front label of the second product can be placed on the second side (verses the first side) of the container type and the back label on the first side (verses the second side). Of course to further accentuate the difference between the two products (using the same container type) different colors, different labels, different brand names, and the like may also be used.

A product comprises a container having a label affixed thereto, preferably a front label and a back label. One skilled in the art will readily identify the difference between a “front label” and a “back label.” A front label, for a fabric care product, typically has a brand name (e.g., TIDE or DOWNY) prominently displayed, a description of what the product is (e.g., laundry detergent, fabric softener), scent (“original” or “lavender & sweet vanilla”), volume of contents, number of uses, and warning or cautions, or combinations thereof. A back label typically has directions for using the product, cautions or warnings, manufacturer, UPC label, and contact information for questions or comments, or combinations thereof. Labels may be affixed to containers by those means known in the art such as shrink wrapping, printing, flexographic printing, ink-jet printing, adhesive labels, and the like. In one embodiment, only two labels (verses three or more labels) on the product are used.

FIGS. 1-7 show an example of a neck 18 of a container 4. In one embodiment the container 3 comprises a neck 18 suitable for grasping by the shopper. A neck may be used to carry the product or utilize the product by the shopper. The first panel 9 and second panel 12 may extend vertically above the base 15 to form a neck 18, wherein the neck 18 is below the cylindrical opening 6. The neck 18 is below the cylindrical opening 6 of the container 3. The neck may also comprise a neck ridge 27 about proximal and below to the opening 6. The neck ridge 27 provides a circumferential ridge around the neck 18 of the container 3 to help the shopper's hand from slipping from the neck 18 when grasping the product. In one embodiment, the neck 18 has an axial, cross-sectional area from about 15 cm2 to about 35 cm2, alternatively from about 20 cm2 to about 30 cm2—measured at the smallest axial, cross-sectional area of the neck. In one embodiment, the product may be free of a handle (see e.g., U.S. Design 556,039). In yet another embodiment, the opening of the container is non-cylindrical.

One aspect of the invention provides products comprising a cap (functionally attached to the container). The cap may have radial asymmetry with the objective of having a single cap type, that depending up its orientation relative to the “front” of the product, will provide different ornamental appearances to the shopper. This way, different products can presented with different container and cap ornamentation all by orientating a single container type and single cap type to the shopper.

The cap, in one embodiment, may be a screw-on cap. The cap, in another embodiment, may serve as means of dosing the composition to a laundry machine or wash basin (in laundry hand wash applications). The cap may also be double walled to allow any residual composition that remains after dosing to flow back into the container.

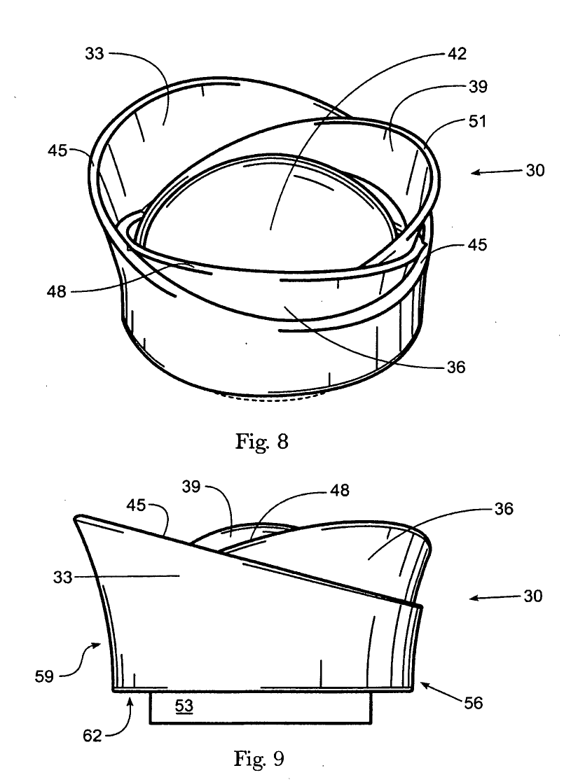

A non-limiting example of a cap 3 having radial asymmetry is described in FIGS. 8-14. FIG. 8 is a perspective view of the cap 30. The cap 30 has three asymmetric concentric lobes, specifically an inner lobe 39, a middle lobe 36, and an outer lobe 33. These lobes 39, 36, 33 all each comprise respective ridges, that is, an inner lobe ridge 51, a middle lobe ridge 48, and an outer lobe ridge 45. The cap also has a bulbous region 42 located generally at the center and top of the cap 30.

FIG. 9 is a front view of the cap 30 of FIG. 8. From this front view, the outer lobe ridge 45 and middle lobe ridge 48 visually intersect to form an angle of about 120 degrees. The cap 30 comprises an inner wall 53 and an outer wall 56. When the cap 30 is functionally attached to the container, the inner wall 53 of the cap 30 is inside the container typically extending into or through the cylindrical opening of the container. The inner wall 53 of the cap 30 is generally not visible to the shopper (unless the container material is transparent) whereas the outer surface 59 of the outer wall 56 of the cap 30 is visible to the shopper. The inner surface 62 of the outer wall 56 is typically not visible to the shopper and may comprise threading (to allow the cap to be screwed on to the container, i.e., functionally attach).

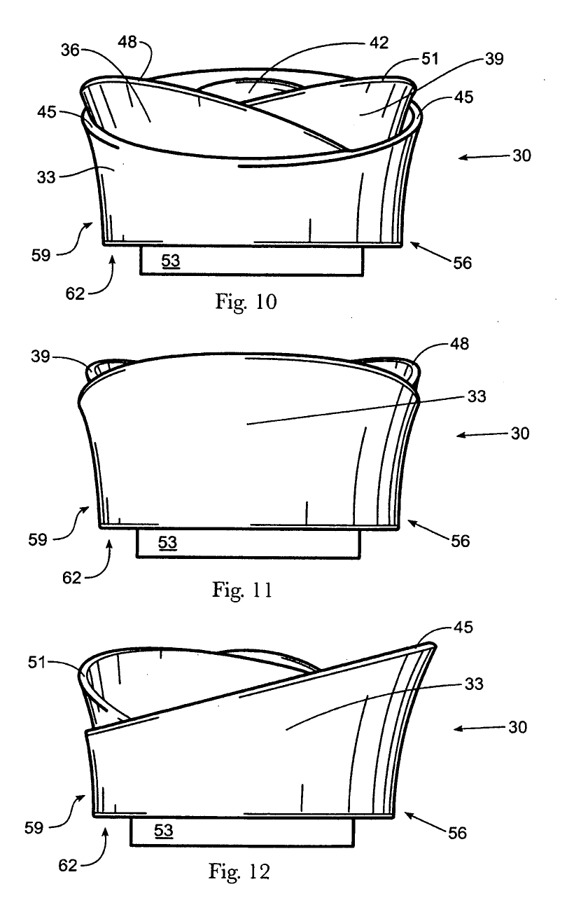

FIG. 10 is a right view of the cap 30 of FIG. 8. From this right view, the middle lobe ridge 48 and inner lob ridge 51 visually intersect to form an angle of about 120 degrees.

FIG. 12 is a back view of cap 30 of FIG. 8. From this back view, the inner lobe ridge lobe ridge 51 and outer lobe ridge 45 visually intersect to form an angle of about 120 degrees.

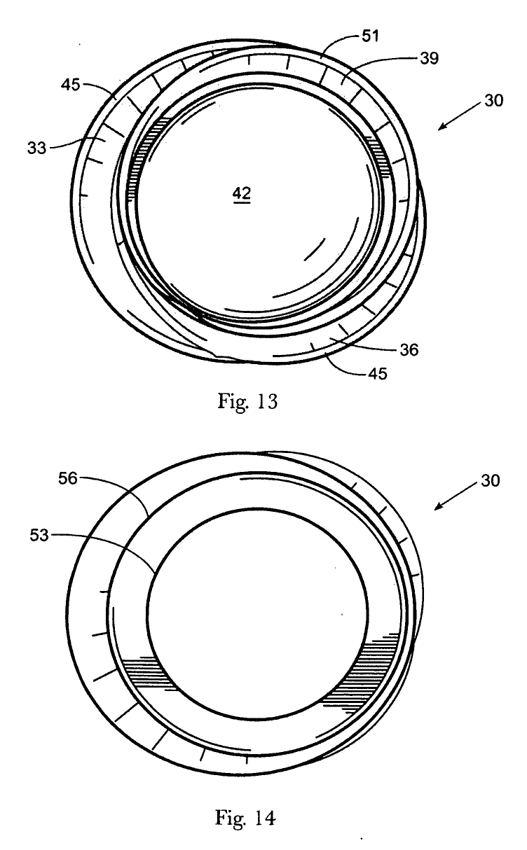

FIG. 13 is a top view of the cap 30 of FIG. 8. The radial asymmetry of the cap 30 is best observed from this top view. FIG. 14 is a bottom view of the cap 30 of FIG. 8. The inner wall 53 and outer wall 56 are concentric.

In one embodiment, the cap comprises an overall height of about 3 cm to about 9 cm, alternatively from about 4 cm to about 8 cm, alternatively from about 5 cm to about 7 cm. In another embodiment, the diameter of the inner wall of the cap comprises from about 3 cm to about 5 cm. The overall diameter of the cap comprises from about 3 cm to about 7 cm (at its largest diameter).

While the specification concludes with the claims particularly pointing and distinctly claiming the invention, it is believed that the present invention will be better understood from the following description.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages and ratios used herein are by weight of the total composition and all measurements made are at 25° C., unless otherwise designated. An angular degree is a planar unit of angular measure equal in magnitude to 1/360 of a complete revolution.

All measurements used herein are in metric units unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited are, in relevant part, incorporated herein by reference; the citation of any document is not to be construed as an admission that it is prior art with respect to the present invention.

What is claimed is:

1. A liquid fabric softener product comprising a container containing a liquid fabric softener composition, wherein the container comprises a base, a first panel and second panel extending vertically above the base to form a cylindrical opening at about the top of the container; wherein:
(a) the base comprises a length and a width, wherein the length is at least as long as the width;
(b) the first panel and second panel are adjacent along a longitudinal plane,
(i) wherein the longitudinal plane is a flat linear plane: generally symmetrically dividing an axial plane of the cylindrical opening; and dividing an axial plane of the length of the base;
(ii) wherein the first panel is neither generally symmetrical nor generally a mirror image of the second panel.

2. The product of claim 1, wherein the longitudinal plane divides the axial plane of the length of the base generally symmetrically.

3. The product of claim 1, wherein the container further comprises a double walled cap.

4. The product of claim 1, wherein the first panel comprises a first design element, wherein the second panel does not comprise the first design element.

5. The product of claim 4, wherein the second panel comprises a second design element, wherein the first panel does not comprise the second design element.

6. The product of claim 5, wherein the first panel comprises a third design element, wherein the second panel does not comprise the third design element.

7. The product of claim 6, wherein the second panel comprises a fourth design element, wherein the first panel does not comprise the fourth design element.

8. The product of claim 1, wherein the container is free of a handle.

9. The product of claim 1, wherein the container further comprises a neck, wherein the neck comprises an axial cross sectional area from about 20 cm2 to about 30 cm2 at the smallest cross sectional area of the neck.

10. The product of claim 1, wherein:
(a) the container further comprises a double walled cap;
(b) wherein the first panel comprises a first design element, wherein the second panel does not comprise the first design element;
(c) wherein the container further comprises a neck, wherein the neck comprises an axial cross sectional area from about 20 cm2 to about 30 cm2 at the smallest cross sectional area of the neck; and
(d) wherein the volume of composition contained in the container is from about 1 liter to about 2 liters.

11. The product of claim 1, further comprising cap, wherein the cap has generally rotational asymmetry from a top perspective view of the cap.

12. An array of fabric softener products comprising:
(a) a first product comprising:
(i) a first container containing a first fabric softener composition, wherein the first container is a type according to claim 1;
(ii) a first front label and a first back label affixed to the first container;
(b) a second product comprising:
(i) a second container containing a second fabric softener composition, wherein the second container is the type according to claim 1;
(ii) a second front label and a second back label affixed to the second container;
(d) wherein the first panel of the first product comprises the first front label; and
(e) wherein the first panel of the second product comprises the second back label.

13. The array of claim 12, wherein the second panel of the first product comprises the first back label, and the second panel of the second product comprises the second front label.

14. The array of claim 13, wherein the first and second containers each further comprise a double walled cap.

15. The array of claim 13, wherein the container further comprises a neck, wherein the neck comprises an axial cross sectional area from about 20 cm2 to about 30 cm2 at the smallest cross sectional area of the container neck.

16. The array of claim 14, wherein the container further comprises a neck, wherein the neck comprises a axial cross sectional area from about 20 cm2 to about 30 cm2 at the smallest cross section area of the container neck.

17. The array of claim 14, wherein the first product and second product comprise a cap, wherein the cap is the same cap type, and wherein the cap has generally rotational asymmetry from a top perspective view of the cap.

18. The array of claim 15, wherein the orientation of the rotation asymmetric cap is the same for the first product and the second product.

19. A method of treating laundry comprising the step of dosing composition from the product of claim 1 to a laundry washing machine.
